(19) United States
(12) Patent Application Publication
(10) Pub. No.: US 2024/0209534 A1
(43) Pub. Date: Jun. 27, 2024

(54) PROCESS AND SYSTEM TO ENHANCE AND SUSTAIN ELECTROLYSER PERFORMANCE OF CARBON-DIOXIDE ELECTROLYSERS

(71) Applicants: Szegedi Tudomanyegyetem, Szeged (HU); eChemicles Zrt., Szeged (HU)

(72) Inventors: Ferenc DARVAS, Budapest (HU); Balázs ENDRÖDI, Szeged (HU); Csaba JANÁKY, Szeged (HU); Richard JONES, Budapest (HU); Egon KECSENOVITY, Horgos (RS); Angelika SAMU, Csongrád (HU)

(21) Appl. No.: 18/005,817

(22) PCT Filed: Jul. 17, 2020
(86) PCT No.: PCT/HU2020/050033

§ 371 Date: Jan. 17, 2023

(51) Int. Cl. C25B 15/025; C25B 1/23; C25B 3/26; C25B 9/23; C25B 9/77; C25B 11/032; C25B 15/027; C25B 15/029; C25B 15/031; C25B 15/08

(52) U.S. Cl. CPC C25B 15/025; C25B 1/23; C25B 9/23; C25B 9/77; C25B 11/032; C25B 15/027; C25B 15/029; C25B 15/031; C25B 15/087; C25B 3/26

(57) ABSTRACT

An electrolyser (100) for continuous electrolysis of gaseous carbon dioxide, CO₂, includes an anode with an anode catalyst layer, a cathode with a cathode catalyst layer formed as a gas-diffusion electrode, GDE, an ion-conducting separator layer arranged between the anode and the cathode, an anode compartment formed in contact with the anode, and a cathode compartment formed in contact with the cathode. A flow of gaseous CO₂ is directed through the cathode compartment and a flow of anolyte is directed through the anode compartment to perform electrolysis of said CO₂. From time to time, one of (i) a liquid flow containing alkali or alkali-earth metal cations, or (ii) a gaseous flow comprising at least one of isopropanol vapor, ethanol vapor, gaseous ammonia, N₂H₄, HCl, sulfur dioxide and nitrous oxide is directed through the cathode compartment, thereby activating the GDE.

### FIELD OF THE INVENTION

The present invention relates to the field of generating high value products via electrolysis of gaseous carbon dioxide. In particular, the invention relates to a process and system to enhance and sustain electrolyser performance of carbon-dioxide electrolysers during continuous operation of said electrolysers for an extended period of time with no loss of conversion rate and efficiency. Said carbon-dioxide electrolyser can be a carbon-dioxide electrolyser constructed as either a single electrolyser cell or multiple electrolyser cells, i.e., comprising an electrolyser cell-stack. An electrolyser cell-stack, here and from now on, is comprised of multiple electrolyser cells, wherein the individual cells are connected in series in terms of the electrical connections of the cells and connected in series/parallel in terms of the flow management of the electrolyser, i.e., the liquid flows and the gaseous flows directed through the electrolyser.

### BACKGROUND ART

Carbon dioxide (CO₂) is a greenhouse gas; hence, using renewable energy to convert it to transportation fuels and commodity chemicals is a value-added approach to the simultaneous generation of products and environmental remediation of carbon emissions. The large amounts of chemicals produced worldwide that can be potentially derived from the electrochemical reduction (and hydrogenation) of CO₂ highlight further the importance of this strategy. Electrosynthesis of chemicals using renewable energy (e.g. solar or wind energy) contributes to a green and more sustainable chemical industry. Due to the variety of possible CO₂ derived products, polymer-electrolyte membrane (PEM) based electrolysers are of particular attraction.

A typical configuration of a PEM based CO₂ electrolyser consists of a separator (an ion-exchange membrane or a diaphragm) which is either in direct contact with the catalyst layers (zero gap cells), or is separated from those by liquid layers (anolyte and catholyte on the anode and cathode sides, respectively). The cathode electrocatalyst is immobilized on a porous gas diffusion layer (GDL), forming thereby the cathode gas-diffusion electrode (GDE).

Zero-gap electrolysers function without liquid catholyte, which allows operation at lower cell voltages (which in turn results in higher energy efficiency). Extended continuous operation of a zero-gap CO₂ electrolyser with alkaline anolyte leads, however, to a precipitate formation on the cathode. This is also true for non-zero gap devices (i.e., where liquid catholyte flows), but to a smaller extent. This crystallite formation is attributed to the formation of metal-carbonate or metal-bicarbonate salts (e.g., K₂CO₃ or KHCO₃) which takes place because of the crossover of cations of the anolyte from the anodic side to the cathodic side (in zero-gap cells) or because of the presence of a catholyte (in non-zero gap cells).

The precipitate formation in the cathode GDE decreases the electrolyser performance by blocking the way of the reactant gas to the catalyst layer. This also leads to pressure buildup in the cell, which distorts the elements within the cell, i.e. can damage cell integrity and results in loss of electrolyser performance of the cell. To avoid this, thus, regeneration is needed. Here, and from now on, the term “regeneration of the electrolyser” will refer to a process to restore the electrolyser performance. When continuous operation is also of issue, this requires mechanical and/or chemical mobilization or dissolution of the precipitate without disassembling the electrolyser.

An attempt for this is to continuously dose water or water vapor in the CO₂ gas stream. Although this solution represents the current state-of-the-art, it may cause the flooding of the cell, leading to decreased selectivity for CO₂-reduction product formation (and increase H₂ evolution). Moreover, GDEs in these electrochemical cells are designed to be hydrophobic, to allow the reactant CO₂ to reach the catalyst surface in the gas phase, instead it being dissolved in ample amount of water, causing mass transport limitations in the conversion process. When rinsing the cathode compartment of the electrolyser with water, therefore only precipitate formed on the back of the GDE (e.g., in the gas-flow pattern) can be removed, but not that formed in the pores of the GDL. To press water into the pore structure of the GDE, an excessive force (i.e., pressure) is required, which in turn damages the structure of the GDL and (micro-)cracks are formed. Such microcracks allow water to flow through the GDL, therefore the whole GDE gets flooded after some time, which hampers long-term operation of these devices. The regenerating solution must therefore be tailored to the hydrophilic/hydrophobic nature of the used GDE and the operation conditions of the electrolyser.

Anion exchange membrane (AEM) based operation, in principle, is independent of the fact whether an alkaline solution (most typically KOH, NaOH, or CsOH) or water is fed at the anode (given that the anodic electrocatalyst functions in both media). Despite of this, the electrolyser performance (in terms of product formation rate and selectivity) of zero-gap CO₂ electrolysers with deionized water as anolyte has been found unsatisfactorily low for industrial application. A major difference between the operation of the electrolyser with an alkaline anolyte and pure deionized water is that metal cations cross the membrane in the first case from the anode to the cathode, leading to the presence of these ions on the surface of the cathode catalyst layer.

In the field of continuous CO₂ conversion by means of electrolysis in electrolyser cells or stacks, a great deal of technical solutions is known.

In particular, a comprehensive summary of the current state-of-the-art of the development of continuous-flow electrolysers for CO₂ reduction is given by B. Endrödi et al. (see Prog. Energy Combust. Sci. 2017, 62, pp. 133-154. https://doi.org/10.1016/j.pecs.2017.05.005). The paper describes some possible embodiments of the electrolysers, the most important criteria and descriptors for the efficient operation thereof, and some of possible electrolyser failure mechanisms. Moreover, the review spans the basic design concepts of electrochemical cells (either microfluidic or membrane-based), the employed materials (e.g. catalysts, support, etc.), as well as the operational conditions (e.g. type of electrolyte, role of pressure, temperature, etc.).

US Published Patent Appl. No. 2018/0274109 A1 discloses an apparatus with a full operation environment for CO₂ electrolysers, including fluid control and electrochemical instrumentation framework. It does include a refresh supply unit, which can infuse water into the cathode or anodic side of the cell to refresh it. According to the application, said refresh supply unit is to be operated when the cell operation is unsatisfactory in terms of cell voltage, cell current and/or when the Faradaic efficiency of the desired product does not satisfy request criteria.

US Published Patent Appl. No. 2019/0127865 A1 describes a possible embodiment of an electrolyser for continuous CO₂ reduction. The most important electrolyser elements and operating conditions are described. In particular, the application discloses an electrochemical device and method involving bipolar membrane electrolysis to transform an input product into an output product. Some embodiments include a GDE as a cathode, a bipolar membrane configured to facilitate auto-dissociation, and an anode that can be configured as a liquid-electrolyte style electrode or a GDE. In some embodiments the electrochemical device can be configured as a CO₂ electrolyser that is designed to utilize input product including gaseous carbon dioxide and water to generate output products that can include gaseous carbon monoxide or other reduction products of carbon dioxide and gaseous oxygen or the oxidation products of a depolarizer such as hydrogen, methane, or methanol.

B. Endrödi et al. (for further details, see ACS Energy Lett. 2019, 4 (7), pp. 1770-1777; https://doi.org/10.1021/acsenergylett.9b01142) teaches about the possibility of stacking multiple electrolyser cells in a single electrochemical stack to increase the product formation rate and/or conversion efficiency. Rinsing the cathodes of the electrolyser cells with water, or with high temperature water vapor is presented as a strategy to maintain the performance of the electrolyser cell-stack.

Furthermore, previous studies in H-type electrochemical cells and microfluidic CO₂ electrolysers proved the promoting effect of alkali-cations in the electrochemical reduction of CO₂ (for further details, see a paper by J. Resasco et al. in J. Am. Chem. Soc. 2017, 139 (32), pp. 11277-11287). Such an effect has not yet been observed or reported with zero-gap CO₂ electrolysers, most probably due to the lack of liquid catholyte in this case.

However, none of the cited prior art proposes a solution for the above-referred problems which arise when the CO₂ electrolyser is operated over an extended period of time continuously, i.e., without periodical stopping for maintenance, i.e. for cleansing or replacing spoilt/clogged GDEs.

Similarly, neither have been demonstrated before such CO₂ electrolysers which are capable of performing a stable (i.e., a duration of at least about 150 h) and high current density (i.e., over 400 mA cm⁻²) operation with deionized water as anolyte.

Hence, there would be a need for a technique by means of which the maintenance of continuously operated CO₂ electrolysers can be performed without their stopping, i.e., with no need to disassemble said electrolysers. Putting another way, to sustain the electrochemical or electrolyser performance of CO₂ gas-fed electrolysers, there is a need for a novel operational process and system which also allow for the regeneration of CO₂ electrolysers in operation.

Hence, there would be also a need for a technique by means of which the electrochemical or electrolyser performance of present CO₂ gas-fed electrolysers making use of either deionized water or an alkaline solution as anolyte, specifically at least in terms of their stability and current density, is enhanced.

In light of this, the main object of the present invention is to eliminate or at least to alleviate the drawbacks of the state-of-the-art CO₂ gas fed electrolysers in terms of the loss in their electrolyser performance over time.

Another object of the present invention is to provide a way of operating CO₂ gas-fed electrolysers making use of either deionized water or an alkaline solution as anolyte with no interruption (e.g., disassembling the electrolyser cell(s) for maintenance) over an extended duration of time.

Additional objects, as well as aspects, features and advantages, of the present invention will be set forth in the following description.

### SUMMARY OF THE INVENTION

We found in our studies that chemical mobilization of the precipitate that forms in and clogs the pores of the cathode GDE over time in CO₂ gas-fed electrolysers can simply be enhanced by performing regeneration of the cathode during operation of CO₂ electrolysers from time to time, preferably periodically, by means of introducing a regeneration agent into the cathode compartment which is capable of wetting the cathode GDE. In particular, the regeneration agent is a liquid solvent of proper wetting properties in respect of the cathode GDE(s) to be used within the electrolyser cell or cell-stack to be regenerated. Preferably, the regeneration agent is provided in the form of a mixture of at least two liquid solvents which, when mixed together, form the solvent mixture of proper wetting properties in respect of the cathode GDE(s) made use of within the electrolyser cell or cell-stack to be regenerated. As a consequence of the wetting capability, the regeneration agent can enter into the pores of GDE(s), dissolve and expel the precipitate from the pores without destructing the pore structure of the GDE(s).

To obtain the regeneration agent with appropriate wetting properties for a certain GDE, a great number of solvents, or mixtures formed thereof, can be used. In particular, any of the solvents selected from the group of acetone, acetonitrile, chloroform, diethyl ether, diethylene glycol, dimethyl-formamide, ethyl acetate, ethylene glycol, glycerol, tetrahydrofuran, xylene, water, deionized water, methanol, ethanol, 1-propanol, 2-propanol, 1-butanol, 2-butanol, pentanol, pentane, hexane, heptane, cyclohexane can be equally used as the regeneration agent either alone or in combination to form a solvent mixture compatible with a GDE to be regenerated. Selection of the regeneration agent to be used (i.e., its components and the ratio of components in case of a solvent mixture) depends on the wettability of the GDE concerned. As wettability of a GDE is known from manufacturer's specification or can be measured before assembling an electrolyser, it is a routine task for a skilled artisan to determine the kind of regeneration agent and, in particular, its components/composition to be applied for the subsequent regeneration during continuous operation of the electrolyser.

As specific examples, water cannot penetrate into carbon-based, polytetrafluoro-ethylene (PTFE) containing GDEs (such as e.g. Sigracet 39BC, Freudenberg H23C6, etc.) due to their hydrophobicity, and therefore the use of less polar regeneration agents (e.g. water/isopropanol mixture) is necessary, while GDEs formed of porous titanium frits can be regenerated by water, as water wets the GDE properly. It was found, that the solvent mixture of 2-propanol (isopropanol) and deionized water (from now on DI water) with a volume ratio of at least about 1:3 is an especially preferred solvent mixture; the greater is the isopropanol proportion in said solvent mixture, the more appropriate/compatible the solvent mixture is for carbon-based GDEs in terms of its wetting properties.

Furthermore, we have also found that for a certain GDE and regeneration agent, a complete regeneration of the electrolyser requires a definite amount of regeneration agent either in the form of a single solvent or a solvent mixture. That is, raising the amount of regeneration agent used to regenerate the electrolyser to above this amount, no further enhance in e.g. the conversion efficiency is measured. In particular, depending on the GDE and the regeneration agent selected for regeneration, the maximum amount of the regeneration agent ranges from about 0.01 to 1000 times, more preferably from about 0.1 to 100 times, and most preferably from about 1 to 50 times the empty volume of the cathode compartment of the electrolyser cell or cell-stack containing said GDE(s). Since this volume can be determined e.g. at least experimentally, it is a routine task for a skilled artisan to determine the amount (volume) of the regeneration agent to be used in one regeneration cycle of the cathode GDE(s) of a CO₂ gas-fed electrolyser.

We have found in our studies that to achieve high reaction rates, in zero-gap CO₂ gas-fed electrolysers, the cation permeation through the separation membrane during continuous operation with alkaline electrolyte is the key.

We have surprisingly found that by introducing small volumes of especially alkali and/or alkali-earth metal solutions (e.g. KOH, NaOH, CsOH, and similar compounds) or other suitable compounds into the cathode compartment of the electrolyser cell or cell-stack while continuously operating the electrolyser with pure deionized water as anolyte, an increase in both CO₂ reduction rate and selectivity appear, i.e., the electrolyser performance gets enhanced. The extent of increase is in correlation with the wettability of the cathode(s), or rather the cathode GDE(s), with the alkali or alkali-earth metal solution infused into the cathode compartment of the electrolyser cell or cell-stack. Here, and from now on, the term “activation of the electrolyser” will refer to a process of infusing an electrolyte (or promoter) containing solvent or solvent mixture into the cathode compartment. Thus, we found that by performing periodic activation of the cathode GDE, carried out preferably simultaneously with the regeneration of the electrolyser, the electrolyser performance can be increased from time to time, i.e., the electrolyser performance can be sustained for an extended period of time during the operation of the electrolyser. Said activation can also be performed either before or after the regeneration of the electrolyser.

Promoter(s) can be applied either in liquid or gaseous phase. The liquid phase of the promoter is obtained by dissolving said promoter in a liquid solvent, preferably in a solvent mixture used for the regeneration.

As promoter, any compounds selected from the group of NaCl, LiF, Li₃PO₄, Cs₂CO₃, Na₂CO₃, Li₂CO₃, K₂CO₃, Rb₂CO₃, CaSO₄, NaNO₃, K₂SO₄, KHCO₃, NaHCO₃, LiHCO₃, CsHCO₃, RbHCO₃, RbOH, FrOH, NH₃, CsOH, KOH, NaOH, Ca(OH)₂, Ba(OH)₂, Mg(OH)₂, BaHCO₃, Mg(HCO₃)₂, MgCO₃, BaCO₃, CaCO₃, Sr(OH)₂, SrCO₃, Sr(HCO₃)₂, as well as any mixture thereof, can be used dissolved in a liquid solvent, preferably in a solvent mixture used for the regeneration. The compounds of KOH, NaOH, CsOH are especially preferred.

As gaseous promoter, a compound selected from the group of isopropanol vapor, ethanol vapor, ammonia, N₂H₄, HCl, sulphur dioxide, nitrous oxide, as well as any mixture thereof, can be used, depending on the employed catalyst. Moreover, gaseous compounds of strongly polar nature are also applicable as promoter. These promoters act based on their specific adsorption on the catalyst layer, modifying its electronic and adsorption properties.

Because of the stoichiometry of the electrochemical reactions taking place in electrolyser cells or cell-stacks, and due to the chemical nature of AEMs, the pH is always alkaline in the cathode compartment. We have surprisingly found that besides the above-referred alkaline promoters, neutral and even acidic compounds can be used to perform the activation. This observation confirms that the chemical nature of a promoter is more important than the pH of the solution and without bounding ourselves to theory, the observation may also explain the applicability of the mentioned gaseous promoters for the activation of GDEs.

Furthermore, we have also found that for a certain GDE and promoter, complete activation of the electrolyser requires a definite concentration of the promoter. That is, raising the concentration of the promoter used for the activation of the cathode GDE to above this concentration, no further enhance in e.g. the conversion efficiency is measured. Depending on the GDE and the promoter selected for the activation, the maximum concentration of the promoter ranges from about 0.001 to 5 mol·dm⁻³, more preferably from about 0.01 to 3 mol·dm⁻³, and most preferably from 0.1 to 1 mol·dm⁻³.

Furthermore, we have surprisingly found that the adsorption of cations (or the promoters) present in the alkali and/or alkali-earth metal solution infused in the electrolyser cell, i.e., electrosorption on the catalyst of the cathode GDE helps proper functioning, as well as maintaining a proper functioning of the cathode during the continuous electrolytic conversion of CO₂. Since a CO₂ gas-fed electrolyser is electrochemically polarized when it operates, in such cases the electrosorption increases. Nevertheless, the adsorption of promoters also takes place (to a minor extent) when the CO₂ electrolyser does not operate. Hence, the activation can be performed during maintenance period(s), i.e., when the electrolyser is anyway not in operation.

These findings enable the elaboration of a process and to design a system to operate a CO₂ gas-fed electrolyser comprised of either a zero-gap or a non-zero gap elecrolyser cell or cell-stack with deionized water as anolyte with periodic infusions of an activating solution that, beyond any doubt, reduces the operation complexity and the costs of the process of continuous electrolytic conversion of gaseous CO₂, thereby speeding up its industrial implementation.

In particular, the above goals are achieved by a process to enhance electrolyser performance of a continuously operated CO₂ gas-fed electrolyser according to claim 1. Further preferred variants of the process to enhance electrolyser performance are set forth in claims 2 to 12. The above objects are further achieved by a process to sustain electrolyser performance of a continuously operated CO₂ gas-fed electrolyser according to claim 13. Preferred variants of the process to sustain electrolyser performance are set forth in claims 13 to 18. Moreover, the above objects are furthermore achieved by a system to enhance and sustain electrolyser performance of a continuously operated CO₂ gas-fed electrolyser cell in accordance with claim 19. Preferred further embodiments of the system according to the invention are defined by claims 20 to 30.

It should be here noted that said activation process can be accomplished from time to time by a human operator in given time intervals and according to needs based on the measurement data acquired through multiple sensors to continuously monitor and evaluate the electrolyser performance in terms of pressure, temperature, current/voltage values, product selectivity, flow rate(s), humidity, product composition, etc.—just to mention only the most important operation parameters. Optionally, said time intervals may also be preset intervals, if optimal operation is not of a key feature.

However, as is preferred, the activation process is performed in an automated manner. To this end, the system responsible for operating the CO₂ electrolyser is equipped with a processing and control unit, equipped with or implemented as e.g. on artificial intelligence subunit, being capable of making a decision on the necessity of activation in light of the data received from the multiple sensors continuously monitoring and evaluating the electrolyser performance holistically. Thus, when reaching certain criteria in terms of pressure, temperature, current/voltage values, product selectivity, flow rate, product composition (or any combination thereof), the activation process is initiated and performed automatically. Similarly, regeneration of the electrolyser cell can also take place under the supervision of said processing and control unit.

As it will be apparent from the following description and the examples discussed in detail, the activation process according to the invention allows the operation of CO₂ gas-fed electrolysers with deionized water feed at the anode (i.e., as anolyte) for an extended period of time with no need for maintenance and thus interruption, simplifies the overall technology, while making it even more environmentally sustainable.

### BRIEF DESCRIPTION OF THE DRAWINGS

In what follows, the invention is described in detail with reference to the accompanying drawings, wherein

FIG. 1A illustrates schematically the design of a zero-gap electrolyser cell to convert gaseous CO₂ to other products;

FIG. 1B illustrates schematically the design of a non-zero gap electrolyser cell to convert gaseous CO₂ to other products;

FIG. 2 shows a possible embodiment of the system to sustain electrolyser performance of a CO₂ electrolyser;

FIG. 3 shows a possible further embodiment of the system to sustain electrolyser performance of a CO₂ electrolyser in a fully automated manner;

FIGS. 4A, 4B and 4C present the current decrease, a photograph of a clogged gas-diffusion electrode, and a micro-CT image of said gas-diffusion electrode used in a CO₂ electrolyser, respectively, operated continuously with an alkaline anolyte without cathode regeneration/activation;

FIG. 5 shows an example of wetting a carbon-based gas diffusion layer with different water/isopropanol solvent mixtures;

FIG. 6 shows the partial current density for CO and H₂ formation as a function of time during continuous operation of a CO₂ electrolyser for 8 hours with periodic regeneration;

FIGS. 7A and 7B illustrate the total current densities over time during continuous operation of a CO₂ electrolyser with performing activation of the cathode GDE with 1 M KOH solution in pure deionized water and with a solvent mixture of isopropanol/water suitable for wetting the cathode GDE, respectively;

FIGS. 8A and 8B are chronoamperometric curves with the cathode of a DI water anolyte fed CO₂ electrolyser activated with 10 cm³ of different alkaline solutions (c=0.5 M) in a solvent mixture of isopropanol/water during continuous electrolysis;

FIGS. 9A and 9B are chronoamperometric curves with the cathode of a DI water anolyte fed CO₂ electrolyser activated with 10 cm³ of different potassium salt solutions (c(K⁺)=0.5 M) in a solvent mixture of isopropanol/water during continuous electrolysis;

FIG. 10 shows the partial current density for CO and H₂ formation over time during continuous operation of a DI water anolyte fed CO₂ electrolyser for 224 hours with periodic cathode activation with 5 cm³ 1 M CsOH solution in water/isopropanol after each 12 hours of electrolysis;

FIG. 11 shows the total and partial current density for CO formation over time during continuous operation of a DI water anolyte fed CO₂ electrolyser with cathode activation for various anion exchange membranes, in particular A: Class T Sustainion X37-50, B: PiperION TP-85 32 μm, and C: Fumasep FAB-PK-130;

FIG. 12 shows the measured partial current densities for H₂ and CO formation during constant voltage electrolysis with a DI water anolyte fed CO₂ electrolyser cell with cathode activation for various amounts (volumes) of the solvent mixture containing a promoter, here KOH; and

FIG. 13 the measured partial current densities for H₂ and CO formation during constant voltage electrolysis with a DI water anolyte fed CO₂ electrolyser cell with cathode activation for various concentration of the solvent mixture containing a promoter, here KOH.

### DESCRIPTION OF POSSIBLE EMBODIMENTS

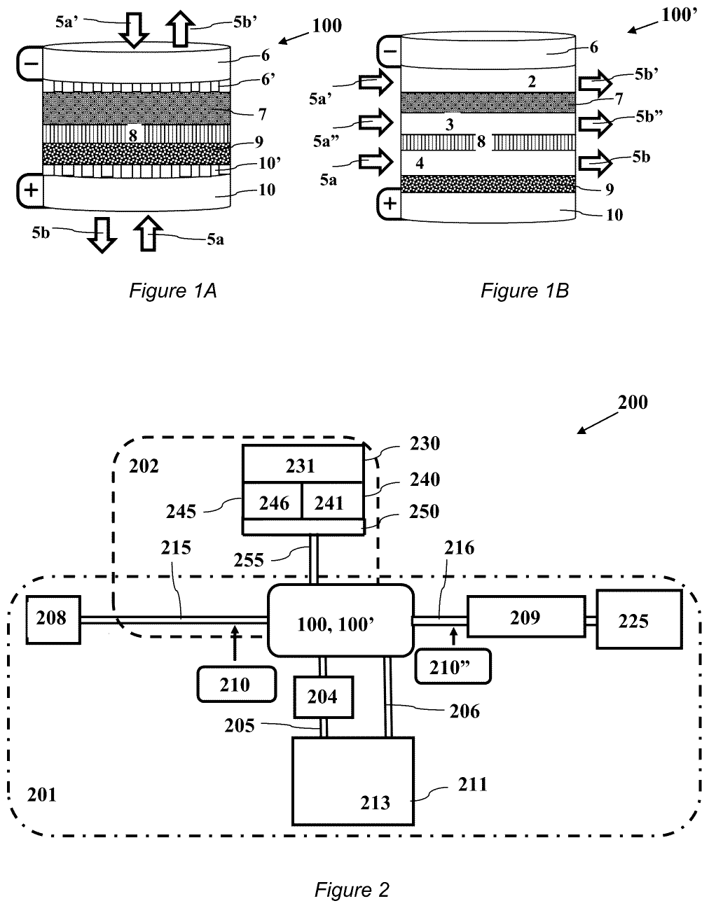

FIG. 1A illustrates schematically a possible embodiment of a zero-gap electrolyser cell 100 to convert gaseous CO₂ to other products. Said electrolyser cell 100 comprises (here, from bottom to top) at least an anode current collector 10 with fluid inlet(s) 5a and fluid outlet(s) 5b on one side thereof and a flow-pattern 10′ formed on the other side, an anode electrode 9 with a catalyst layer (not shown) on one side, a membrane 8, in direct contact with said catalyst layer, a cathode catalyst layer (not shown) in direct contact with the membrane 8 on one side, and the cathode electrode 7 on the other side, and a cathode current collector 6, on which a gas-flow pattern 6′ is formed on one side thereof (in direct contact with the cathode electrode 7), while gas inlet(s) 5a′ and outlet(s) 5b′ are formed on the other side. As is clear for a skilled artisan, each of the anode electrode 9 and the cathode electrode 7 can be provided in the form of a gas-diffusion electrode (with a respective catalyst layer). Said electrolyser cell 100 may also be constructed as an electrolyser cell-stack, consisting of multiple electrolyser layers (cells). In this case, multiple electrolyser layers are stacked on each other, repeating the anode, anode catalyst, membrane, cathode catalyst and cathode elements. Between the adjacent layers, preferably bipolar plates are used, which on one side act as anode, while serve as cathode on the other side. Such bipolar plates are known in literature.

FIG. 1B illustrates schematically a possible embodiment of a non-zero gap electrolyser cell 100′ to convert gaseous CO₂ to other products. Said electrolyser 100′ comprises (here, from bottom to top) an anode current collector 10, an anode electrode 9 with a catalyst layer, an anolyte flow channel 4 with an inlet 5a and an outlet 5b, a membrane 8, a catholyte flow channel 3 with an inlet 5a″ and an outlet 5b″, a cathode catalyst layer (not illustrated) facing the membrane 8, a cathode electrode 7 carrying said cathode catalyst layer, a gas channel 2 for gaseous CO₂ with an inlet 5a′ and an outlet 5b′, and a cathode current collector 6. Optionally, a single electrolyte solution may be used to separate the anode and cathode catalyst layers, replacing the anolyte flow channel 4, the membrane 8 and the catholyte flow channel 3. Each channel has at least one inlet and at least one outlet. As is clear for a skilled artisan, each of the anode electrode 9 and the cathode electrode 7 can be provided in the form of a gas-diffusion electrode (with a respective catalyst layer). Said electrolyser cell 100′ may also be constructed as an electrolyser cell-stack, consisting of multiple electrolyser cells. In this case, multiple electrolyser cells are stacked on each other, repeating the anode, anode catalyst, anolyte, membrane, catholyte, cathode catalyst, cathode and gas channel and cathode elements.

The anode current collector 10, the cathode current collector 6, the anode electrode 9, the cathode electrode 7, the catalysts and the flow channels 2, 3, 4 and the flow patterns 6′, 10′ applied in the electrolyser cells 100, 100′, as well as their functions and possible design are equally known in literature.

Furthermore, the membrane 8 is an anion exchange membrane, available under the trade names of e.g. Fumasep, Selemion, PiperION and Sustainion, just to mention a couple of examples only, which allows, in operation, the migration of anions (e.g., OH⁻, HCO₃⁻ and CO₃²⁻ ions; charges) between the cathodic and anodic sides of the electrolyser cell 100, 100′ through its bulk, while water (H₂O) diffusing through said cells 100, 100′ from the anodic to the cathodic side takes part in the electrolytic reduction of CO₂ at the cathodic side. As in this case no electrons are transported through the membrane 8, said membrane 8 actually acts as an ionic conductor between the cathodic and anodic sides of the cells 100, 100′.

In what follows, the operation of a system to enhance and sustain electrolyser performance of electrolyser cells during continuous electrolytic conversion of gaseous CO₂ to a product stream according to the invention, as well as some preferred embodiments thereof are explained in detail. Here, zero-gap electrolyser cells and non-zero gap electrolyser cells are discussed together, although there are some differences between the operations of the two types of cells, as is apparent to a skilled artisan, e.g. the application of liquid catholyte flow through the cell in the case of non-zero gap electrolyser cells. When appropriate, the differences will also be discussed in brief.

FIG. 2 illustrates a possible embodiment 200 of the system which can be used with both the CO₂ gas-fed zero-gap electrolyser cell 100 and the non-zero gap electrolyser cell 100′ to convert gaseous CO₂ by electrolysis into one or more products for further applications, in a continuous manner and with an alkaline anolyte having an alkaline concentration of 0 to 3 M (including DI water, too) as the anolyte for an extended period of time without being stopped for e.g. maintenance, and at high current densities. To this end, said system 200 comprises a control subsystem 201 for the traditional operation of the cell 100, 100′ and a regeneration/activation subsystem 202 to perform regeneration and/or activation of the cathode of the cell 100, 100′ from time to time, according to needs. The control subsystem 201 and the regeneration/activation subsystem 202 are in operative couplings with one another.

As part of the control subsystem 201, a CO₂ source 208 provides the CO₂ feedstock for the conversion which takes place in the cell 100, 100′. Said CO₂ source 208 connects to an inlet (e.g. inlet 5a′ in FIG. 1A or inlet 5a′ in FIG. 1B) of the cathodic side of the cell 100, 100′ through a piping 215 made of suitable material, e.g., stainless steel. Said CO₂ source 208 may be equipped with a controlled dispensing valve (not illustrated) to ensure precise metering and dispensing of the CO₂ feedstock to form a cathode-side circulation assembly. Optionally, a humidifier (not shown in FIG. 2) can be inserted into the piping 215 to add/mix a given amount of water vapour to the CO₂ feedstock. Gaseous products produced from CO₂ within the cell 100, 100′ via electrolysis leave the cell 100, 100′, as a mixture which may also contain unconsumed CO₂, through appropriate outlets (e.g. outlet 5b′ in FIG. 1A or outlet 5b′ in FIG. 1B) of the cathodic side of the cell 100, 100′ into a piping 216 made of suitable material, e.g., stainless steel. Said piping 216 transports the products from the cell 100, 100′ to various analyser units, e.g. a (gas) flow rate measuring unit 209 and/or a (gas) composition measuring unit 225. The flow rate measuring unit 209 measures the flow rate of the (gaseous) mixture of products leaving the electrolyser cell 100, 100′. As is apparent to a skilled artisan, any kind of (gaseous) flow rate meter can be applied here. The composition measuring unit 225 measures and determines the composition of the (gaseous) mixture of products leaving the electrolyser cell 100, 100′. As is also apparent to a skilled artisan, any kind of composition measuring device can be applied.

A first set 210 of sensors is arranged along piping 215 upstream of the electrolyser cell (100, 100′) to measure various parameters of the CO₂ feedstock before entry into the electrolyser cell 100, 100. Said first set 210 of sensors comprises at least one pressure gauge, at least one temperature sensor and, optionally, if e.g. the CO₂ feedstock is humidified, i.e. also contains water vapor, at least one moisture sensor.

A second set 210″ of sensors is arranged along piping 216 downstream of the electrolyser cell (100, 100′) to measure various parameters of the product(s) leaving the electrolyser cell 100, 100′. Said second set 210″ of sensors comprises at least one pressure gauge, at least one temperature gauge, at least one moisture sensor and at least one pH sensor. Said second set 210″ of sensors is arranged preferentially between the outlet (e.g. outlet 5b′ in FIG. 1A or outlets 5b′ and 5b″ in FIG. 1B) of the cell 100, 100′ and an inlet of the applied analyser units.

As part of the control subsystem 201, a liquid tank 211 containing an anolyte 213 is in fluid communication with an inlet (e.g. inlet 5a in FIG. 1A or inlet 5a in FIG. 1B) of the anodic side of the cell 100, 100′ through a piping 205 made of suitable material, e.g., stainless steel to form an anode-side circulation assembly. To form a closed continuous flowpath on the anodic side of the cell 100, 100′ between the anodic side and the liquid tank 211, an outlet (e.g. inlet 5b in FIG. 1A or inlet 5b in FIG. 1B) of the anodic side of the electrolyser cell 100, 100′ is also in fluid communication with said liquid tank 211 through a piping 206 made of suitable material, e.g., stainless steel. Through the closed flow-path, the anolyte 213 is circulated by means of a pump 204 between the anodic side and the liquid tank 211 through an appropriate system of fluidic channels formed in the anode itself to refresh the anolyte 213 (if needed) which gets spoilt in electrochemical reaction(s) at the anodic side in the cell 100, 100′. Said pump 204 is preferably inserted into the piping 205.

In case of using the non-zero gap CO₂ electrolyser cell 100′, a further set of electrolyte container, electrolyte solution, pump and piping is to be applied (not shown), preferably as part of the cathode-side circulation assembly, to circulate a catholyte in the cell 100′, similarly to the anolyte container 211, the anolyte 213, the pump 204 and the piping 206 in the system 200. Practical implementation of such a set of further means is considered to be a routine task for a skilled artisan and/or can be found in literature.

Preferably, the anolyte 213 is pure DI water, however, it can be any kinds of alkaline anolyte suitable for being used in CO₂ electrolysers according to literature. In particular, the anolyte is preferably an alkaline liquid with an alkaline concentration of 0 to 3 M. Furthermore, as is known by the skilled artisan, the type of anolyte 213 used depends on the type of anion-exchange membrane and the catalysts applied in the electrolyser cell 100, 100′ itself.

As part of the control subsystem 201, a processing and control unit (not shown in FIG. 2) is also provided. The processing and control unit is connected (e.g. electrically) with any sensor elements in said first set 210 of sensors and in said second set 210″ of sensors, as well as any analyser units, i.e., the flow rate measuring unit 209 and the composition measuring unit 225 to receive (e.g. electric) signals representative of the measured values of various physical and chemical parameters measured in the system 200 in order to control the operation of the electrolyser cell 100, 100′ coupled to said system 200 either manually or in an automated manner (to be discussed later on).

As is also apparent to a skilled artisan, the system 200 also comprises an appropriate electric power supply (not illustrated) for energizing the electrolyser cell 100, 100′. To this end, to polarize the electrolyser cell 100, 100′, a negative pole of the power supply is electrically connected with the cathodic side of said cell 100, 100′, while a positive pole of the power supply is electrically connected with the anodic side of the cell 100, 100′. The power supply can be either the grid itself or any local source of electricity, i.e. a solar, wind, nuclear one. A battery, either a disposable or a secondary one, can be equally used as power supply. If required, said power supply also energizes the processing and control unit, as well as said pump 204.

Furthermore, as part of the regeneration/activation subsystem 202, a promoter tank 230, at least a first solvent tank 240 and a second solvent tank 245 are provided. Said promoter tank 230 contains a promoter 231, either in the gaseous or in the liquid phase. Said first solvent tank 240 contains a first liquid solvent 241, said second solvent tank 245 contains a second liquid solvent 246 which preferably differs from said first solvent 241. Further promoter tanks, each containing a possible further promoter substance, preferentially differing from any other promoter substances, can also be provided. Further solvent tanks, each containing a possible further solvent, being preferentially different from any other solvents, can be also provided. Optionally, if merely one solvent is used for the regeneration/activation instead of a solvent mixture, the first and second solvent tanks 240, 245, as well as said further solvent tanks, can be replaced with a single solvent tank. In what follows, however, such an embodiment of the system 200 is discussed in detail which uses at least two different solvents for this purpose.

All of said tanks, i.e., the promoter tank 230, the first solvent tank 240, the second solvent tank 245, as well as any other promoter tanks and solvent tanks, if present, are in fluid communication with a mixing tank 250, through appropriate valves known by the skilled artisan. The mixing tank 250 is capable of receiving and mixing controlled amounts of said solvents 241, 246, as well as, optionally, at least one promoter 231 to form a solvent mixture which, optionally, also comprises a promoter substance. Said mixing tank 250 is in fluid communication with an inlet (e.g. inlet 5a′ in FIG. 1A or inlet 5a′ in FIG. 1B) of the cathodic side of the cell 100, 100′ through a piping 255 made of suitable material, e.g., stainless steel. Preferably, a controlled dispensing valve (not illustrated in FIG. 2) is inserted into the piping 255 for controlling the amount of the fluid flow, i.e. the solvent mixture with promoter substance fed or infused into said inlet of the electrolyser cell 100, 100′. All the valves are in operative coupling with the processing and control unit in order they be under full control of the latter.

The solvents 241, 246 contained in any of the first, second and further solvent tanks 240, 245 are selected from the group comprised of acetone, acetonitrile, chloroform, diethyl ether, diethylene glycol, dimethyl-formamide, ethyl acetate, ethylene glycol, glycerol, tetrahydrofuran, xylene, water, DI water, methanol, ethanol, 1-propanol, 2-propanol, 1-butanol, 2-butanol, pentanol, pentane, hexane, heptane, cyclohexane, and, at higher temperatures, vapors thereof, as well as any similar compounds. Furthermore, gaseous solvents, i.e. alkaline or acidic vapors of e.g. HCl, HBr, SO₂, NH₃, etc. may be equally used with some trivial modifications in the system 200.

Liquid phase (i.e., dissolved) promoter(s) 231 contained in the promoter tank(s) is/are selected from the group comprised of NaCl, LiF, Li₃PO₄, Cs₂CO₃, Na₂CO₃, Li₂CO₃, K₂CO₃, Rb₂CO₃, CaSO₄, NaNO₃, K₂SO₄, KHCO₃, NaHCO₃, LiHCO₃, CsHCO₃, RbHCO₃, RbOH, FrOH, NH₃, CsOH, KOH, NaOH, Ca(OH)₂, Ba(OH)₂, Mg(OH)₂, BaHCO₃, Mg(HCO₃)₂, MgCO₃, BaCO₃, CaCO₃, Sr(OH)₂, SrCO₃, Sr(HCO₃)₂, as well as any mixture thereof. As is also apparent to a skilled artisan, the promoter 231 can be provided as a solid substance as well. To obtain said liquid phase promoter, in such a case, at first the solid promoter has to be dissolved in a suitable solvent.

Gaseous phase promoter(s) 231 contained in the promoter tank(s) is/are selected from the group comprised of isopropanol vapor, ethanol vapor, ammonia, N₂H₄, HCl, sulphur dioxide, nitrous oxide, as well as any mixture thereof in which the components do not react with each other upon mixing or being mixed together.

In operation, carbon dioxide supplied by the CO₂ source 208 of the system 200 is fed to the cathodic side of the CO₂ gas-fed electrolyser cell 100, 100′. In the presented CO₂ electrolyser system 200, products form in the electrolysis reactions taking place in said cell 100, 100′. Depending on the catalysts used within the cell 100, 100′ and the applied CO₂ electrolysis reaction conditions, various products are obtained; as non-exhausting examples (i) syngas (CO/H₂ mixture with controlled composition), (ii) methane, (iii) ethylene, (iv) methanol, and (v) ethanol are mentioned here. The products forming in the cathodic part leave the cell 100, 100′ and then are introduced into the product analyser units, that is, into the flow rate measuring device 209 and then the composition determining device 225 to determine the product flow rate and the product composition. Based on the measured data, the material balance of the electrolytic process undergoing within the cell 100, 100′ can be determined and then made use of for controlling/regulating the conversion process. The anolyte 213 is directly and continuously fed into the anodic side of the cell 100, 100′ with the pump 204. Said anolyte 213 flows through the anodic side of the cell 100, 100′ and collects gaseous oxygen forming in the electrolysis reaction along its path. When the stream of anolyte 213 leaves the cell 100, 100′, and before being recirculated into said cell 100, its oxygen content gets preferably released. Notably, other value-added anode processes (other than water oxidation, e.g. chlorine formation or alcohol oxidation) can be coupled to CO₂ conversion, as is clear for a skilled artisan; the architecture of said system 200/cell 100, 100′ is not confined to water oxidation at all. Furthermore, during operation of the system 200, various physical parameters (such as pressure, temperature, humidity, etc.) of the CO₂ feedstock and the products are measured, or monitored by means of the first and second sets 210, 210″ of sensors through the processing and control unit which, as a response to the measured data, operates said valves in order the electrolyser cell 100, 100″ work smoothly and as desired. The operation parameters are known to a skilled artisan, while the implementation of said control/regulation is considered to be a routine work.

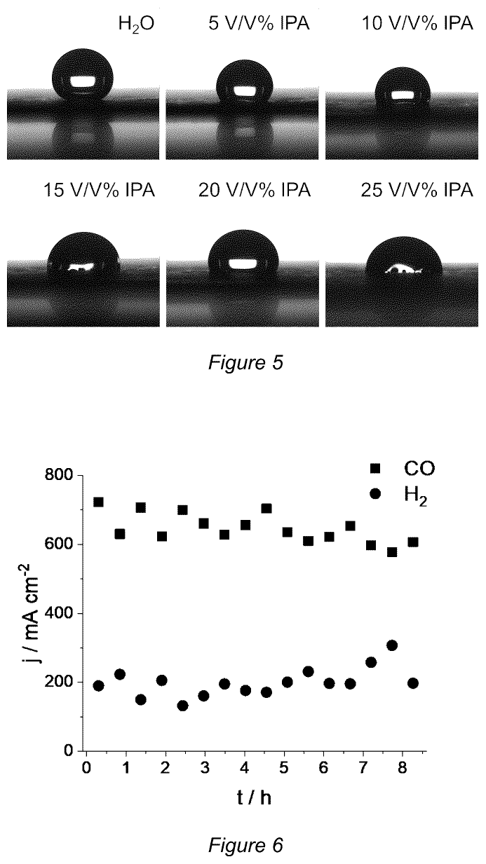

Here, as the anolyte 213, an alkaline anolyte with an alkaline concentration of 0 to 3 M is used (including the case of using pure DI water, too). In case of using an alkaline anolyte 213, to achieve an extended period of functioning (in this regard, see e.g. Example 3 and FIG. 6) of the CO₂ gas-fed electrolyser cell 100, 100′ used with the system 200, in harmony with the inventive concept, the cathodic side of the cell 100, 100′ is regenerated by flushing the cathode compartment located adjacent to the cathode of the cell 100, 100′ from time to time with a regeneration agent, i.e., an appropriate solvent or a solvent mixture of at least two different solvents 241, 246 prepared in the mixing tank 250 to avoid clogging as a consequence of precipitate formation. Said regeneration is performed, preferably periodically, either manually or, on the basis of the values of the parameters measured by the sets 210, 210″ of sensors, in an automated manner. Said regeneration is performed simultaneously with supplying CO₂ to the cell's 100, 100′ inlet (e.g. inlet 5a′ in FIG. 1A or inlet 5a′ in FIG. 1B) by means of said automated valve from the mixing tank 250 under full control of the processing and control unit. Thus, there is no need to stop or interrupt the electrolyser cell 100, 100′ for its regeneration.

Furthermore, to enhance the electrolyser performance (in this regard, see e.g. Examples 4 to 10) and/or to further extend the period of functioning (in this regard, see e.g. Example 7) of the CO₂ gas-fed electrolyser cell 100, 100′ used with the system 200, in harmony with the inventive concept, the cathodic side of the cell 100, 100′ is activated by injecting an appropriate electrolyte, i.e. at least one promoter 231 into the cathode compartment located adjacent to the cathode of the cell 100, 100′ from time to time from the promoter tank 230. Said activation is performed, preferably periodically, either manually or, on the basis of the values of the parameters measured by the sets 210, 210″ of sensors, in an automated manner. Preferentially, the activation is performed simultaneously with the regeneration, that is, the at least one promoter 231 is dispensed into the mixing tank 250 together with said at least two solvents 241, 246, mixed together, and then the thus obtained solvent mixture containing the promoter(s) is injected into the cathode compartment from the mixing tank 250 through the cell's 100, 100′ inlet by means of the automated valve under control of the processing and control unit. Thus, there is no need to stop or interrupt the electrolyser cell 100, 100′ for its activation either. As is apparent to a skilled artisan, a gaseous promoter can be used for the activation in a similar series of steps, naturally with some trivial modifications.

The activation can also be performed separately from the regeneration. In particular, in case of using pure DI water as anolyte 213, the regeneration cycle can be simply omitted. In such a case, under control of the processing and control unit, only at least one promoter 231, in either the liquid or in the gaseous phase, is injected into the cathode compartment by the automated valve. Should there be a need, one of the solvent tanks, e.g. a third solvent tank (not illustrated in FIG. 2), can be used to contain a suitable further solvent for the promoter 231 to adjust its concentration.

Actually, depending on the electrolyser cell 100, 100′ used in the system 200, in particular the cathodic side GDE, activation of the cell 100, 100′ requires a certain concentration of the promoter 231. That is, raising the concentration of the promoter 231 used to activate the cathode GDE to above this concentration, no further enhance in the electrolyser performance of the cell 100, 100′ is obtained. Depending on the GDE and the promoter 231, the maximum concentration of the promoter 231 ranges from about 0.001 to 5 mol·dm⁻³, more preferably from about 0.01 to 3 mol·dm⁻³, and most preferably from 0.1 to 1 mol·dm⁻³, this can be easily obtained by the application of the solvent in said third solvent tank.

To activate the electrolyser cell 100, 100′ in the system 200, usage of KOH, NaOH, CsOH, as promoter, is especially preferred.

As discussed above, the regeneration and/or activation of the electrolyser cell 100, 100′ is carried out when the cell 100, 100′ is operating, that is, when it is polarized. However, as is also apparent to a skilled artisan, said regeneration and/or activation can be performed by means of the system 200 according to the present invention in the switched-off state of the cell 100, 100′ as well.

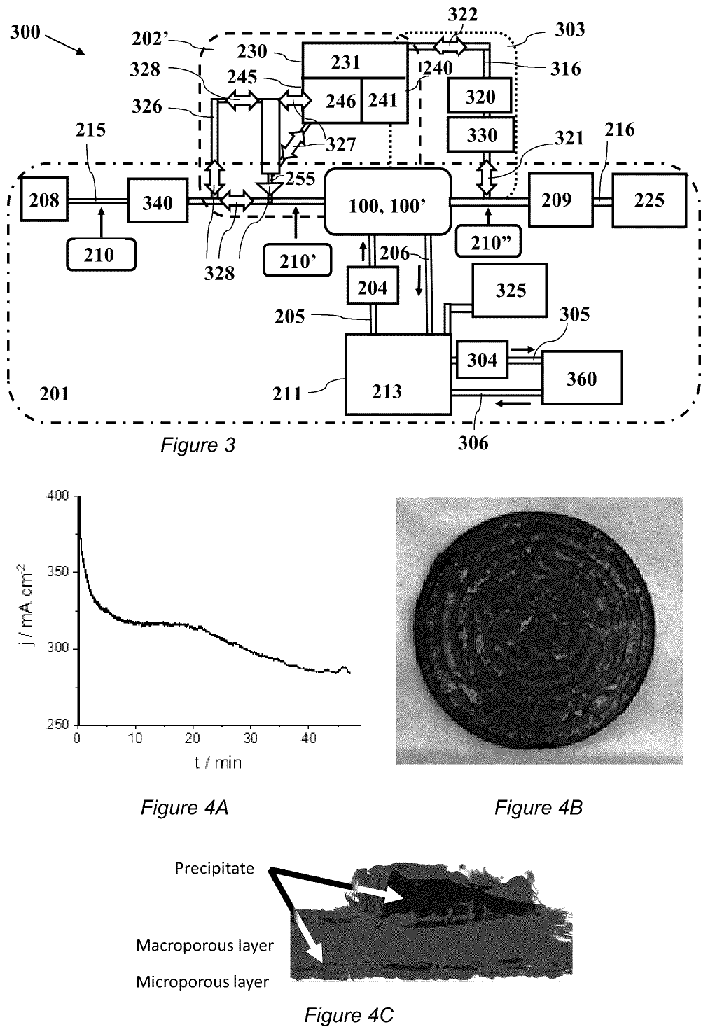

FIG. 3 illustrates a possible further embodiment 300 of the system which can be used with the CO₂ gas-fed zero-gap electrolyser cell 100 or non-zero gap electrolyser cell 100′ to convert gaseous CO₂ by electrolysis into one or more products for further applications, in a continuous manner and with an anolyte with an alkaline concentration of 0 to 3 M as the anolyte for an extended period of time without being stopped (for e.g. maintenance), and at high current densities. In FIG. 3, certain components of the system 300 correspond to components of the system 200 shown in FIG. 2, and hence are represented by the same reference numbers. Nevertheless, system 300 comprises some further units that allow fully automated operation of the electrolyser cell 100, 100′ with regeneration and/or activation from time to time as required in light of the operational parameters continuously monitored in the system 300.

In particular, in a possible embodiment of the system 300, a tempered humidifier 340 is inserted into the piping 215 between the CO₂ source 208 and the electrolyser cell 100, 100′ to control and adjust the water vapor content of the CO₂ feedstock and thereby to provide a humidified CO₂ feedstock for the electrolysis. Automated monitoring of the moisture content in the gaseous CO₂ is assisted by a third set 210′ of sensors which also includes a moisture sensor arranged between the humidifier 340 and the electrolyser cell 100, 100′. The third set 210′ of sensors is arranged along the piping 215 downstream of the humidifier 340 and upstream of the electrolyser cell (100, 100′). Each sensor element in said third set 210′ of sensors is connected electrically with the processing and control unit to provide further measurement data about the system 300 in operation. For the purposes of the present invention, as is apparent to a skilled artisan, any kinds of humidifiers are applicable. As specific examples, membrane humidifiers from Cellkraft AB (Sweden), PermaPure (USA) or Fumatech GmbH (Germany), or similar humidifiers can be used.

In a yet possible further embodiment of the system 300, the regeneration/activation subsystem 202′ is in fluid communication with an inlet (e.g. inlet 5a′ in FIG. 1A or inlet 5a′ in FIG. 1B) of the cathodic side of the electrolyser cell 100, 100′ through an injection loop 326 built into the piping 255. Here, automated valves 327 are used to fill the injection loop 326 with the activating/regenerating compounds from the respective tanks 230, 240, 245, and thus there is no need for the mixing tank. The activating/regenerating compounds can then be injected from the injection loop 326 into the CO₂ stream in the piping 215 by controlled opening/closing of further automated valves 328. The valves 327, 328 are operated by the processing and control unit (part also of the control subsystem 201; not shown in FIG. 3). Any of the temperature, composition and pH of the injected mixture are continuously monitored and controlled by respective sensor elements also provided in the third set 210′ of sensors.

In a yet possible further embodiment of the system 300, a promoter recirculating subsystem 303 is also provided to reclaim the promoter passed through the electrolyser cell 100, 100′ after performing the activation thereof. The promoter recirculating subsystem 303 is comprised of a piping 316 connecting the promoter tank 230 and a section of the piping 216 located between the outlet (e.g. outlet 5b′ in FIG. 1A or outlets 5b′ and 5b″ in FIG. 1B) of the electrolyser cell 100, 100′ and an inlet of the product analyser units (here, e.g. that of the flow rate measuring unit 209) through appropriate automated valves which are electrically connected with said processing and control unit. The valve to provide a selective flow connection between the piping 316 and said section of the piping 216 is preferably a three-path control valve 321. The valve to provide a flow connection between the piping 316 and the promoter tank 230 is preferably a bidirectional valve 322. Between the valves 322 and 321, a purifier unit 320 to purify the separated promoter, and a liquid/gas separator unit 330 to separate gaseous and liquid phases (containing the promoter) exiting from the cell 100, 100′ are inserted into the piping 316.

The promoter recirculating subsystem 303 starts operating simultaneously with the regeneration/activation subsystem 202′, which injects the promoter into the electrolyser cell 100, 100′, which after passing said cell 100, 100′ is separated from the product stream by means of the promoter recirculating subsystem 303. The purified promoter is then directed back in the promoter fluid tank 230 of the activation/regeneration subsystem 202′. The operation of this subsystem 303 is triggered and continuously monitored by the process and control unit of the control subsystem 201 part of the system 300.

In a yet possible further embodiment of the system 300, an anolyte refresher unit 360 to refresh and recirculate the spoilt anolyte 213 into the liquid tank 211 is also provided. Said anolyte refresher unit 360 is in fluid communication with the liquid tank 211 through pipings 305 and 306 made of suitable material, e.g., stainless steel. A pump 304 is inserted into one of the pipings 305, 306 to effect circulation of the anolyte 213 between the liquid tank 211 and said anolyte refresher unit 360. Preferably, the anolyte refresher unit 360 operates periodically, if the composition of the anolyte 213 measured by a composition measuring unit 325 under the supervision of the processing and control unit of the control subsystem 201 part of the system 300 makes it necessary. The application of the anolyte refresher unit 360 reduces the operation cost of the electrolysis process. Suitable anolyte refresher units 360 are known to the skilled artisan and commercially available. The anolyte refresher unit 360 may be a pH and concentration control instrument, such as Metrohm Titrando or Mettler Toledo (Switzerland) automatic titrators, which monitors the composition of the anolyte 213 and doses given chemicals to the anolyte 213 to restore its original composition. Said anolyte refresher unit 360 may also contain a liquid/gas and a liquid/solid separator inserted into the pipings 305, 306 in order to further improve the quality of the fresh anolyte fed into the electrolyser cell 100, 100′.

Preferably, the processing and control unit of the control subsystem 201 is equipped with or implemented as an artificial intelligence (AI) subunit. Here, any AI systems (based e.g. on a neural network, or one or more cooperative neural networks, etc.) that can be learned with or capable of self-learning from the operation patterns of the system 200, 300 under supervision, adapted properly to the electrolyser cell 100, 100′ associated therewith, are suitable from the point of view of the invention. The AI subunit is responsible for the operation of the system 200, 300 as a whole, as well as the electrolyser cell 100,100′. This subunit operates the main hardware framework of the system 200, 300 (i.e., automated valves for the gas- and liquid management, electrolyser cell or cell-stack, power supply, various sensors, analyser units, such as e.g. (gas) flow rate meters, (gas) composition measuring units, etc.) and a PC controlled (semi)automatic software which monitors, collects and evaluates all the data from the various subunits. Based on this, to maintain maximum process efficiency, the system 200, 300 automatically optimizes the operation conditions (such as e.g. temperature, gas flow rate, electrolyser voltage/current, pressure etc.) through descriptors constructed from the subunits' data. When any of the descriptors reaches/exceeds pre-defined (or, optionally, set by the AI subunit itself as part of the learning process) (e.g. lower) threshold values, the processing and control unit of the control subsystem 201 triggers the operation of the regeneration/activation subsystem and the promoter recirculating subsystem. As an example, a pressure increase within the electrolyser cell 100, 100′ indicates the blocking of its gas channels, and initiates a regeneration/activation operation. Similarly, a regeneration/activation operation is initiated when the composition of the cathodic product stream, continuously measured and analysed by the composition measuring unit 225, is unsatisfactory in terms of useful product to unwanted by-product ratio (i.e., too low CO/H₂ ratio). Furthermore, when e.g. the total current density decreases during constant voltage operation of the electrolyser cell 100, 100′ (see for example FIG. 4A in Example 1) faster than a certain threshold rate (e.g. 100 mA·cm⁻²·h⁻¹) for over a pre-set time period, e.g. of 10 minutes, or alternatively upon a cell/cell-stack voltage increase of a certain threshold value, a regeneration operation can also be initiated. As part of an optimized operation, when all of said descriptors reach or exceed respective further (e.g. upper) threshold values, which overall represent a desired operation of the electrolyser cell 100, 100′, the regeneration/activation operation is stopped by the system 200, 300.

In light of the operation of system 200, as well as the modifications effected in the structure of system 300 relative to that of system 200, the operation of system 300, in particular the way of regeneration/activation performed thereby is apparent to a skilled artisan, and hence is not detailed here.

In what follows, some further aspects of the regeneration/activation process according to the invention is discussed in more detail through Examples 1 to 10 based on experiments.

### Example 1: Operating the Electrolyser without Cathode Regeneration/Activation

In this comparative example, the performance fading of the electrolyser cell during continuous operation with alkaline anolyte is demonstrated. The decreasing current (hence product formation rate) is associated with precipitate formation, and the consequent improper gas management in the electrolyser.

FIG. 4A shows the continuous current decrease during continuous operation at a constant cell voltage (ΔU=3.0 V) with alkaline 1 M potassium hydroxide (KOH) anolyte.

Here, the cathode was formed by immobilizing 3 mg cm⁻² silver (Ag) cathode catalyst on Sigracet39BC carbon paper by spray coating. As for the anode, 1 mg cm⁻² iridium (Ir) black was immobilized on a porous titanium frit. The measurements were performed feeding T=50° C. 1 M KOH anolyte continuously to the anode compartment (at a feed rate of ˜9 cm³ cm⁻² min⁻¹), while the cathode compartment was purged with humidified (with T=50° C. deionized water) CO₂ at a flow rate of u=12.5 cm³ cm⁻² min⁻¹.

FIG. 4B demonstrates that an improper gas management arises due to the formation of a precipitate on the GDE, which blocks the gas path to the catalyst layer.

Furthermore, FIG. 4C shows a micro-CT image of a GDE after using it in the continuous-flow electrolysis of CO₂ with an alkaline anolyte (1 M KOH). Lighter parts show the structure of the GDE (e.g. carbon fibers). The dark, black regions prove the presence of a precipitate on top of the GDE (formed in the gas-flow channels of the electrolyser) and within the pores.

That is, operating the CO₂ electrolyser with no cathode regeneration/activation results clearly in the formation of a precipitate in the GDE, i.e., both on the backside of the GDE, and also within the pores.

### Example 2: Importance of Wetting Properties of the GDE

The present comparative example clearly shows that the composition of the regeneration/activation liquid (or the solvent mixture, optionally containing a promoter) must be tailored to allow its access to the deeper regions of the GDE, hence to the catalyst layers.

FIG. 5 shows the example of wetting a carbon-based GDL with different solvent mixtures. Water alone does not wet the carbon GDL in this example, hence it can only be forced in the structure by excessive force (e.g. pressure), which might destroy the GDL structure. However, increasing the hydrophobicity of the solvent mixture by adding isopropanol (IPA) to DI water, wetting of the GDL improves. In particular, the solvent mixture of DI water/isopropanol with a content of at least about 25 V/V/% IPA (1:3 volume ratio of IPA/DI water) wets the GDL completely. Thus, such a solvent mixture can easily be infused into the pores of the GDL, without damaging the GDL itself.

Composition of the solvent mixture capable of wetting the cathode and thus applicable in the activation process according to the invention depends on the choice of GDL; however, to determine appropriate pairs of solvent mixture/GDL and the useful composition of said solvent mixture is a routine task for a skilled artisan.

### Example 3: Effect of Periodic Regeneration for Continuous Operation

The present example proves that a CO₂ electrolyser can be operated continuously at high current density with alkaline anolyte when a periodic regeneration is applied.

To this end, FIG. 6 shows the partial current density for CO and H₂ formation during the continuous operation of a CO₂ electrolyser for 8 hours at ΔU=3.2 V. The cathode of the electrolyser was regenerated after each hour of the electrolysis. According to this example, the electrolyser performance (current density, selectivity) is sustained by the periodic regeneration.

Here, the cathode was formed by immobilizing 1 mg cm⁻² Ag cathode catalyst on Sigracet39BC carbon paper by spray coating. As for the anode, 1 mg cm⁻² Ir black was immobilized on a porous titanium frit. The measurements were performed feeding T=60° C. 0.1M caesium hydroxide (CsOH) anolyte continuously to the anode compartment (at a feed rate of ˜9 cm³ cm⁻² min⁻¹), while the cathode compartment was purged with humidified (T=60° C. deionized water) CO₂ at a flow rate of u=12.5 cm³ cm⁻² min⁻¹. In the electrolyser cell, a PiperION TP-85 membrane was used to separate the anode and the cathode.

### Example 4: Effect of Electrolytes in Different Solvents on Activating the Cathode GDE

The present example proves that the solvent is crucial for the cathode activation when using dissolved promoter(s).

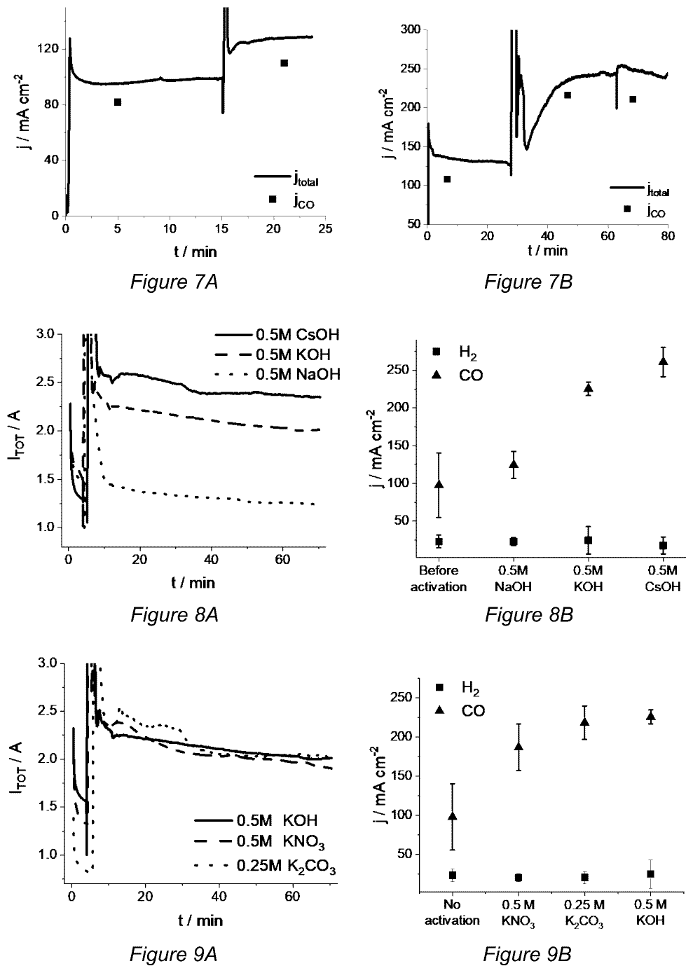

FIGS. 7A and 7B show two measurements when the cathode of the electrolyser is activated during continuous electrolysis at ΔU=3.1 V, applying pure DI water anolyte. In both cases 10 cm³ 0.5 M KOH solution was injected in the gas stream, carried into the cathode compartment by the reactant CO₂ gas. For the measurement shown in FIG. 7A, pure DI water was used as solvent, while the solvent was an isopropanol/DI water mixture suitable for wetting the cathode GDE for the measurements shown in FIG. 7B. The effect is similar in the two cases, but a much larger degree of activation occurs using the solvent mixture which properly wets the GDE.

Here, the cathode was formed by immobilizing 3 mg cm⁻² Ag cathode catalyst on Sigracet39BC carbon paper by spray coating. As for the anode, 1 mg cm⁻² Ir black was immobilized on a porous titanium frit. The measurements were performed feeding T=60° C. pure DI water as anolyte continuously to the anode compartment (at a feed rate of ˜9 cm³ cm⁻² min⁻¹), while the cathode compartment was purged with humidified (T=60° C. deionized water) CO₂ at a flow rate of u=12.5 cm³ cm⁻² min⁻¹. In the electrolyser cell, a Sustainion X37-50 membrane was used to separate the anode and the cathode.

### Example 5: Effect of Cations (as Promoters) on Activating the Cathode GDE with Different Electrolytes

The present example proves that different electrolyte solutions can act as promoters. The degree of the activation depends on the used promoter. In this example the effect of different cations is demonstrated for the case of using dissolved electrolytes for cathode activation.

FIG. 8A shows chronoamperometric curves with the cathode of the electrolyser activated with 10 cm³ of different alkaline solutions (c=0.5 M) in an isopropanol/DI water mixture suitable for wetting the cathode GDE during continuous electrolysis at ΔU=3.1 V, applying DI water as anolyte. FIG. 8B illustrates the derived partial current densities for CO and H₂ production, with the cathode of a CO₂ electrolyser activated with 10 cm³ of different alkaline solutions (c=0.5 M) in an isopropanol/DI water mixture suitable for wetting the cathode GDE during continuous electrolysis at ΔU=3.1 V, applying DI water anolyte. The promoter solutions were injected into the gas stream, carried into the cathode compartment by the reactant CO₂ gas, i.e., simultaneously with the operation of the electrolyser, leading to a significant increase in the overall and partial current densities.

Here, the cathode was formed by immobilizing 3 mg cm⁻² Ag cathode catalyst on Sigracet39BC carbon paper by spray coating. As for the anode, 1 mg cm⁻² Ir black was immobilized on a porous titanium frit. The measurements were performed feeding T=60° C. pure DI water as anolyte continuously to the anode compartment (at a feed rate of ˜9 cm³ cm⁻² min⁻¹), while the cathode compartment was purged with humidified (T=60° C. DI water) CO₂ at a flow rate of u=12.5 cm³ cm⁻² min⁻¹. In the electrolyser cell, a Sustainion X37-50 membrane was used to separate the anode and the cathode.

In this experiment only the type of cation was changed, keeping the solution volume, concentration, and the anion unchanged.

### Example 6: Effect of Anions (as Promoters) on Activating the Cathode GDE with Different Electrolytes

The present example proves that different electrolyte solutions can act as promoters. The degree of the activation depends on the used promoter. In this example we demonstrate the effect of different anions for the case of using dissolved electrolytes for cathode activation.

FIG. 9A shows chronoamperometric curves with the cathode of a CO₂ electrolyser activated with 10 cm³ of different potassium salt solutions (c(K⁺)=0.5 M) in an IPA/DI water mixture suitable for wetting the cathode GDE during continuous electrolysis at ΔU=3.1 V, applying DI water anolyte. FIG. 9B shows the derived partial current densities for CO and H₂ production, with the cathode of the electrolyser activated with 10 cm³ of different potassium salt solutions (c(K⁺)=0.5 M) in an isopropanol/DI water mixture suitable for wetting the cathode GDE during continuous electrolysis at ΔU=3.1 V, applying DI water as anolyte. The promoter solutions were injected into the gas stream, carried into the cathode compartment by the reactant CO₂ gas, leading to a significant increase in the overall and partial current densities.

Here, the cathode was formed by immobilizing 3 mg cm⁻² Ag cathode catalyst on Sigracet39BC carbon paper by spray coating. As for the anode, 1 mg cm⁻² Ir black was immobilized on a porous titanium frit. The measurements were performed feeding T=60° C. DI water as anolyte continuously to the anode compartment (at a feed rate of ˜9 cm³ cm⁻² min⁻¹), while the cathode compartment was purged with humidified (T=60° C. DI water) CO₂ at a flow rate of u=12.5 cm³ cm⁻² min⁻¹. In the electrolyser cell, a Sustainion X37-50 membrane was used to separate the anode and the cathode.

In this experiment only the type of anion (and therefore the solution pH) was changed, keeping the solution volume, the potassium cation and its concentration unchanged.

### Example 7: Effect of Periodic Cathode Activation on Long-Term CO₂ Electrolysis

The present example proves that the electrolyser can be operated continuously with pure DI water as anolyte when a periodic activation is performed.

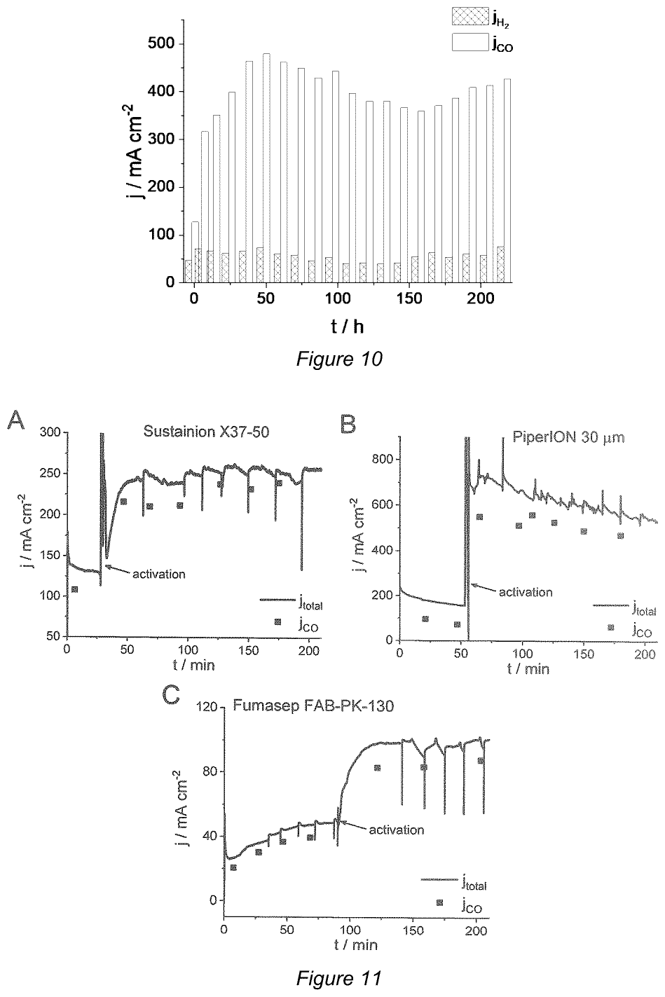

FIG. 10 shows the partial current densities for CO and H₂ formation during the continuous operation of a CO₂ electrolyser for 224 hours at ΔU=3.2 V, applying DI water anolyte. The cathode of the electrolyser was activated periodically (every 12 hours) by injecting 5 cm³ 1 M CsOH into the CO₂ gas stream, which carried it to the cathode GDE. According to this example the electrolyser performance (current density, selectivity) is sustained by the periodic activation.

Here, the cathode was formed by immobilizing 1 mg cm⁻² Ag cathode catalyst on Sigracet39BC carbon paper by spray coating. As for the anode, 1 mg cm⁻² Ir black was immobilized on a porous titanium frit. The measurements were performed feeding T=60° C. DI water as anolyte continuously to the anode compartment (at a feed rate of ˜9 cm³ cm⁻² min⁻¹), while the cathode compartment was purged with humidified (T=60° C. deionized water) CO₂ at a flow rate of u=12.5 cm³ cm⁻² min⁻¹. To separate the anode and cathode, a 15 μm thick, PTFE reinforced PiperION TP-85 membrane was used in the electrolyser cell.

### Example 8: Effect of Different Anion Exchange Membranes on Activating the Cathode GDE

The present example shows that the cathode GDE activation can be performed on electrolyser cells assembled with different, commercially available anion exchange membranes. This example proves that the activation effect is general and is not restricted to certain product of certain suppliers.

FIG. 11 shows the total and partial current densities for CO formation during the continuous operation of a CO₂ electrolyser at ΔU=3.1 V, applying DI water anolyte. The cathode of the electrolyser was activated by injecting 10 cm³ 1 M KOH in the CO₂ gas stream, which carried it to the cathode GDE. According to this example the electrolyser performance (current density, selectivity) is significantly increased upon performing the activation process for each type of anion exchange membranes, which is clearly marked by the immediate current increase.

Here, the cathode was formed by immobilizing 3 mg cm⁻² Ag cathode catalyst on Sigracet39BC carbon paper by spray coating. As for the anode, 1 mg cm⁻² Ir black was immobilized on a porous titanium frit. The measurements were performed feeding T=60° C. DI water as anolyte continuously into the anode compartment (at a feed rate of ˜9 cm³ cm⁻² min⁻¹), while the cathode compartment was purged with humidified (T=60° C. DI water) CO₂ at a flow rate of u=12.5 cm³ cm⁻² min⁻¹.

### Example 9: Necessary Amount of Activation Fluids

The present example shows that the efficiency of the cathode GDE activation depends on the volume of the activation fluid. In this example, an increase in the activation efficiency was found up to 10 times the free volume of the cathode compartment using different volume of 0.5 M KOH solution (in an isopropanol/water solvent mixture suitable for wetting the cathode GDE) for the activation. Further volume increase did not lead to further efficiency increase.

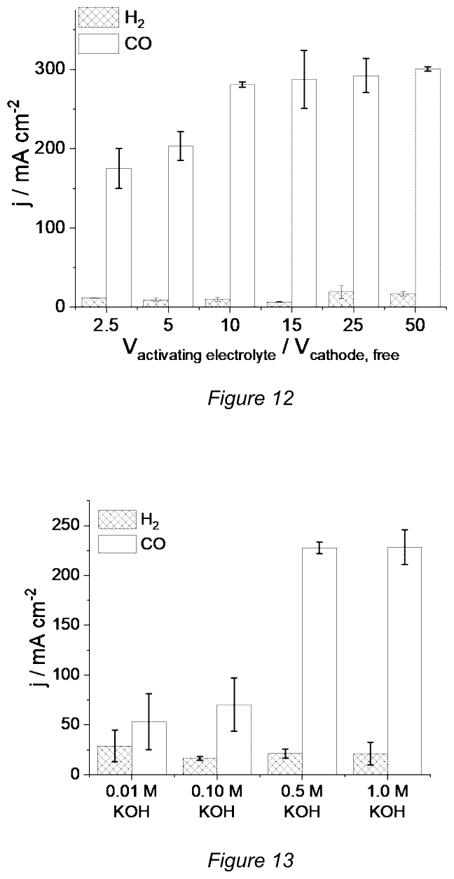

In FIG. 12 the measured partial current densities for H₂ and CO formation during constant voltage electrolysis with T=60° C. DI water as anolyte at ΔU=3.1 V is presented, after activating the cathode with different volume of 0.5 M KOH solution (in the isopropanol/DI water solvent mixture suitable for wetting the cathode GDE).

Here, the cathode was formed by immobilizing 3 mg cm⁻² Ag cathode catalyst on Sigracet39BC carbon paper by spray coating. As for the anode, 1 mg cm⁻² Ir black was immobilized on a porous titanium frit. The measurements were performed feeding T=60° C. DI water as anolyte continuously to the anode compartment (at a feed rate of ˜9 cm³ cm⁻² min⁻¹), while the cathode compartment was purged with humidified (T=60° C. deionized water) CO₂ at a flow rate of u=12.5 cm³ cm⁻² min⁻¹. In the electrolyser cell, a Sustainion X37-50 membrane was used to separate the anode and the cathode.

### Example 10: Necessary Concentration of Activation Fluids

The present example proves, that the efficiency of the cathode GDE activation depends on the concentration of the activation fluid. In this example, an increase in the activation efficiency was found up to the concentration of 0.5 M, using 10 cm³ solution of KOH dissolved in an isopropanol/water mixture suitable for wetting the cathode GDE. Further concentration increase did not lead to further efficiency increase.

In FIG. 13 the measured partial current densities for H₂ and CO formation during constant voltage electrolysis at ΔU=3.1 V with T=60° C. DI water as anolyte is presented, after activating the cathode with 10 cm³ KOH solution of different concentration (dissolved in the isopropanol/water solvent mixture suitable for wetting the cathode GDE). Here, the cathode was formed by immobilizing 3 mg cm⁻² Ag cathode catalyst on Sigracet39BC carbon paper by spray coating. As for the anode, 1 mg cm⁻² Ir black was immobilized on a porous titanium frit. The measurements were performed feeding T=60° C. DI water as anolyte continuously to the anode compartment (at a feed rate of ˜9 5 cm³ cm⁻² min⁻¹), while the cathode compartment was purged with humidified (T=60° C. deionized water) CO₂ at a flow rate of u=12.5 cm³ cm⁻² min⁻¹. In the electrolyser cell, a Sustainion X37-50 membrane was used to separate the anode and the cathode.

1. A process to enhance electrolyser performance of an electrolyser for continuous electrolysis of gaseous carbon dioxide, CO₂, said electrolyser comprising at least an anode with an anode catalyst layer, a cathode with a cathode catalyst layer formed as a gas-diffusion electrode, GDE, an ion-conducting separator layer comprising anion-conducting substance arranged between the anode and the cathode, an anode compartment formed in contact with the anode, and a cathode compartment formed in contact with the cathode, said process comprising:
directing a flow of gaseous CO₂ through the cathode compartment, directing a flow of anolyte through the anode compartment, and performing electrolysis of said CO₂ in the electrolyser, thereby converting said CO₂ into at least one product leaving said electrolyser, and
directing a liquid flow containing alkali metal cations through the cathode compartment on a gas side of said cathode, the liquid flow being also capable of wetting the GDE, thereby activating the GDE.

2. The process according to claim 1, wherein the liquid flow containing alkali metal cations is a liquid flow of at least one promoter, said at least one promoter being selected from a group of compounds NaCl, LiF, Li₃PO₄, Cs₂CO₃, Na₂CO₃, Li₂CO₃, K₂CO₃, Rb₂CO₃, CaSO₄, NaNO₃, K₂SO₄, KHCO₃, NaHCO₃, LiHCO₃, CsHCO₃, RbHCO₃, RbOH, FrOH, NH₃, CsOH, KOH, and NaOH.

3. The process according to claim 2, wherein the at least one promoter has a concentration in said liquid flow of 0.001 to 5 mol/dm³.

4. The process according to claim 1, wherein a total volume of the liquid flow directed through the cathode compartment is 0.01 to 1000 times an empty volume of said cathode compartment.

5. The process according to claim 4, further comprising providing said liquid flow capable of wetting the GDE as a solvent mixture of at least two different solvents.

6. The process according to claim 5, further comprising selecting any solvents from a group consisting of: acetone, acetonitrile, chloroform, diethyl ether, diethylene glycol, dimethyl-formamide, ethyl acetate, ethylene glycol, glycerol, tetrahydrofuran, xylene, water, preferably deionized water, methanol, ethanol, 1-propanol, 2-propanol, 1-butanol, 2-butanol, pentanol, pentane, hexane, heptane, and cyclohexane.

7. The process according to claim 2, further comprising using said liquid flow capable of wetting the GDE for dissolving said at least one promoter.

8. The process according to claim 1, wherein the anolyte is selected from a group of liquids with an alkaline concentration of 0 to 3 M.

9. The process according to claim 8, wherein pure de-ionized water is applied as the anolyte.

10. The process according to claim 8, wherein an alkali-metal containing solution is applied as the anolyte.

11. The process according to claim 1, further comprising directing one of said liquid flow and a gaseous flow comprising at least one of isolpropanol vapor, ethanol vapor, gaseous ammonia, N₂H₄, HCl, sulphur dioxide, and nitrous oxide through the cathode compartment simultaneously with the flow of gaseous CO₂.

12. The process according to claim 1, wherein said electrolyser is a single electrolyser cell or an electrolyser cell-stack comprised of multiple electrolyser cells connected in series in terms of electrical connections of the multiple electrolyser cells and connected in series/parallel in terms of the liquid flows and gaseous flows directed through the cathode compartment of the electrolyser.

13. A process to sustain electrolyser performance of an electrolyser for continuous electrolysis of gaseous carbon dioxide, CO₂, said electrolyser comprising an anode with an anode catalyst layer, a cathode with a cathode catalyst layer formed as a gas-diffusion electrode, GDE, an ion-conducting separator layer comprising anion-conducting substance arranged between the anode and the cathode, an anode compartment formed in contact with the anode, and a cathode compartment formed in contact with the cathode, said process comprising:
(a) by directing a flow of gaseous CO₂ through the cathode compartment and a flow of anolyte through the anode compartment, operating the electrolyser to perform electrolysis of said CO₂ and converting said CO₂ into a product stream leaving said electrolyser;
(b) monitoring at least one parameter of the flow of the gaseous CO₂ flew before entry into the electrolyser, thereby obtaining a first set of measurement data characteristic of actual electrolyser performance of the electrolyser;
(c) monitoring at least one parameter of the product stream after exiting from the electrolyser, thereby obtaining a second set of measurement data characteristic of the actual electrolyser performance of the electrolyser;
(d) monitoring one of a rate of total current density decrease and cell/cell-stack voltage increase of the electrolyser while maintaining the other at a set value, thereby obtaining a third set of measurement data characteristic of the actual electrolyser performance of the electrolyser;
(e) comparing the first set, the second set, and the third set of measurement data characteristic obtained in steps (b) to (d) with nominal or pre-set values of operational parameters of the electrolyser representing a desired electrolyser performance of the electrolyser, thereby obtaining at least one descriptor characteristic of the actual electrolyser performance of the electrolyser;
(f) in case one of the at least one descriptor characteristic determined in step (e) implies that the actual electrolyser performance of the electrolyser is below a pre-defined minimum electrolyser performance, initiating the process according to claim 1 to increase the electrolyser performance of the electrolyser;
(g) updating the at least one descriptor characteristic by repeating steps (b) to (e) along with continuously operating the electrolyser;
(h) in case all of the at least one descriptor characteristic determined in step (e) imply that the actual electrolyser performance of the electrolyser has exceeded the desired electrolyser performance, finishing the process according to claim 1.

14. The process according to claim 13, further comprising monitoring in step (b) at least one of pressure, temperature, flow rate and moisture content of the flow of the gaseous CO₂ as the at least one parameter.

15. The process according to claim 13, further comprising monitoring in step (c) at least one of pressure, temperature, moisture content, pH value, flow rate, composition of the product stream as the at least one parameter.

16. The process according to claim 13, further comprising selecting said at least one descriptor characteristic from a group comprising pressure increase within the electrolyser, composition of the product stream, the rate of total current density decrease, and the cell/cell-stack voltage increase of the electrolyser.

17. The process according to claim 13, wherein the electrolyser is a single electrolyser cell or an electrolyser cell-stack comprised of multiple electrolyser cells connected in series in terms of electrical connections of the multiple electrolyser cells and connected in series/parallel in terms of liquid flows and gaseous flows directed through the cathode compartment of the electrolyser.

18. The process according to claim 13, said process being performed automatedly.

19. A system (200, 300) to enhance and sustain electrolyser performance of an electrolyser cell (100, 100″) during continuous electrolytic conversion of gaseous carbon dioxide, CO₂ to a product stream, said system (200, 300) comprising:
the electrolyser cell (100, 100′) comprising at least an anode with an anode catalyst layer, a cathode with a cathode catalyst layer formed as a gas-diffusion electrode, GDE, an ion-conducting separator layer comprising an anion-conducting substance arranged between the anode and the cathode, an anode compartment formed in contact with the anode, and a cathode compartment formed in contact with the cathode, said electrolyser cell (100, 100′) being provided as one of a single electrolyser cell and an electrolyser cell-stack comprised of multiple electrolyser cells connected in series in terms of electrical connections of the electrolyser cells and connected in series/parallel in terms of substance flows directed through said cathode compartment;
a cathode-side circulation assembly to direct the gaseous CO₂ from a source of gaseous CO₂ through the cathode compartment of the electrolyser cell (100, 100″);
an anode-side circulation assembly to direct liquid anolyte from a source of liquid anolyte through the anode compartment of the electrolyser cell (100, 100″); and
a regeneration/activation subsystem (202) in fluid communication with said cathode-side circulation assembly to provide a liquid flow containing alkali metal cations to direct through the cathode compartment on a gas side of said cathode and to wet the GDE, to activate the GDE by the cathode-side circulation assembly.

20. The system (200, 300) according to claim 19, wherein the regeneration/activation subsystem (202) comprises at least one promoter tank (230) for storing at least one promoter as a source of the alkali metal cations selected from a group of compounds NaCl, LiF, Li₃PO₄, Cs₂CO₃, Na₂CO₃, Li₂CO₃, K₂CO₃, Rb₂CO₃, CaSO₄, NaNO₃, K₂SO₄, KHCO₃, NaHCO₃, LiHCO₃, CsHCO₃, RbHCO₃, RbOH, FrOH, NH₃, CsOH, KOH, and NaOH dissolved in at least one solvent capable of wetting the GDE.

21. The system (200, 300) according to claim 20, wherein the regeneration/activation subsystem (202) further comprises at least one solvent tank (240, 245) for storing the at least one solvent, said at least one solvent being selected from a group consisting of: acetone, acetonitrile, chloroform, diethyl ether, diethylene glycol, dimethyl-formamide, ethyl acetate, ethylene glycol, glycerol, tetrahydrofuran, xylene, water, deionized water, methanol, ethanol, 1-propanol, 2-propanol, 1-butanol, 2-butanol, pentanol, pentane, hexane, heptane, and cyclohexane.

22. The system (300) according to claim 19, wherein the anode-side circulation assembly further comprises an anolyte refreshing unit (360) to refresh and circulate the anolyte through the anode compartment of the electrolyser cell (100, 100′).

23. The system (200, 300) according to claim 19, wherein the cathode-side circulation assembly further comprises a first set (210) of sensors arranged upstream of the electrolyser cell (100, 100′) to provide a first set of parameters characteristic of operation of the system (200, 300) and a second set (210″) of sensors arranged downstream of the electrolyser cell (100, 100′) to provide a second set of parameters characteristic of operation of the system (200, 300).

24. The system (200, 300) according to claim 19, wherein the cathode-side circulation assembly further comprises analyser units (209, 225) for monitoring the product stream and measuring physical/chemical parameters of said product stream that has left the electrolyser cell (100, 100′).

25. The system (300) according to claim 19, wherein the cathode-side circulation assembly further comprises a humidifier (340) arranged upstream of the electrolyser cell (100, 100′) for humidifying the gaseous CO₂ before said gaseous CO₂ enters the electrolyser cell (100, 100′).

26. The system (300) according to claim 25, wherein the cathode-side circulation assembly further comprises a third set (210′) of sensors arranged downstream of the humidifier (340) and upstream of the electrolyser cell (100, 100′) to provide a third set of parameters characteristic of operation of the system (300).

27. The system (200, 300) according to claim 23, wherein the cathode-side circulation assembly further comprises analyser units (209, 225) for monitoring the product stream and measuring physical/chemical parameters of said product stream that has left the electrolyser cell (100, 100′); and further comprising a control subsystem (201) for obtaining said first and second sets of parameters, as well as said physical/chemical parameters, and configured to operate the regeneration/activation subsystem (202) based on the first and second sets of parameters to provide one of the liquid flow containing alkali metal cations and the gaseous flow through the cathode compartment.

28. The system (300) according to claim 27, wherein the cathode-side circulation assembly further comprises a third set (210′) of sensors arranged downstream of the humidifier (340) and upstream of the electrolyser cell (100, 100′) to provide a third set of parameters characteristic of operation of the system (300), and wherein the control subsystem (201) is also configured to obtain said third set of parameters.

29. The system (300) according to claim 27, wherein the control subsystem (201) is configured to automatedly perform a process according to any claim 1.

30. The system (200, 300) according to claim 19, wherein the electrolyser cell (100, 100′) is a zero-gap electrolyser cell (100).
